(19) United States
(12) Patent Application Publication
(10) Pub. No.: US 2007/0058527 A1
(43) Pub. Date: Mar. 15, 2007

(54) Peripheral setting apparatus and method

(75) Inventor: Hyun-wook Park, Gwacheon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/477,490

(22) Filed: Jun. 30, 2006

(30) Foreign Application Priority Data
Jun. 30, 2005 (KR) 2005-58597

(51) Int. Cl. H04J 1/16

(52) U.S. Cl. 370/216

(57) ABSTRACT

A peripheral setting apparatus and method. The peripheral setting apparatus includes a setting information acquiring unit which acquires setting information of a master peripheral that is provided on a network, and a setting unit which sets a new peripheral that is newly provided on the network using the acquired setting information.

### CROSS-REFERENCE TO RELATED PATENT APPLICATION

This application claims the benefit of Korean Application No. 2005-58597, filed Jun. 30, 2005, in the Korean Intellectual Property Office, the disclosure of which is incorporated herein in its entirety by reference.

### BACKGROUND OF THE INVENTION

1. Field of the Invention

An aspect of he present invention relates to a peripheral setting apparatus, and, more particularly, to a peripheral setting apparatus and method which automatically sets a new peripheral which is newly provided on a network using setting information of an existing master peripheral which is already provided on the network, to automatically generate setting information of the new peripheral.

2. Description of the Related Art

In conventional networks, when peripherals are provided on a network and previously set and a user wants to provide an additional peripheral on the network, the user must set the additional peripheral to be recognized on the network. Information on this setting is referred to as setting information. The set peripheral stores the setting information therein. Location information of a host connected to the set peripheral through the network is an example of the setting information. In this case, the set peripheral operates according to the instruction of the host referred to by the setting information.

Generally, peripherals connected to a network all have the same setting information. In this case, a user must find the setting information of existing peripherals in order to set a new or additional peripheral.

The user who wants to set a new peripheral on the network must ask a network manager about the existing setting information or must connect a storage medium having the existing setting information to the new peripheral to read the existing setting information.

As a result, in the conventional peripheral setting method, a troublesome operation is required when setting the new peripheral on the network where the network already has existing peripherals set thereto.

### SUMMARY OF THE INVENTION

An aspect of the present invention provides a peripheral setting apparatus which automatically sets a new peripheral that is newly provided on a network using setting information of an existing master peripheral which is already provided on the network, to automatically generate setting information of the new peripheral.

An aspect of the present invention also provides a peripheral setting method which automatically sets a new peripheral that is newly provided on a network using setting information of an existing master peripheral which is already provided on the network, to automatically generate setting information of the new peripheral.

An aspect of the present invention also provides a computer-readable medium having embodied thereon a computer program for a peripheral setting method which automatically sets a new peripheral that is newly provided on a network using setting information of an existing master peripheral which is already provided on the network, to automatically generate setting information of the new peripheral.

According to an aspect of the present invention, there is provided a peripheral setting apparatus including: a setting information acquiring unit which acquires existing setting information of a master peripheral that is provided on a network; and a setting unit which sets a new peripheral that is newly provided on the network using the acquired existing setting information.

The apparatus may further include a peripheral identifying unit which identifies the master peripheral from at least one peripheral which is previously provided on the network.

The apparatus may further include a setting information requesting unit which requests transmission of the existing setting information; and a responding unit which transmits the existing setting information to the setting information acquiring unit in response to the request.

The apparatus may further include a peripheral identifying unit which multicasts response request data, to which only the master peripheral responds, to at least one peripheral provided on the network, and the setting information requesting unit may request transmission of the setting information to the responding unit provided to the peripheral which responds to the response request data.

The apparatus may further include a setting information analyzing unit which analyzes the acquired existing setting information and extracts a setting value included in the existing acquired setting information, and the setting unit may set the new peripheral according to the extracted setting value.

The apparatus may further include a setting information generating unit which generates the existing setting information, and the acquired existing setting information may be the generated existing setting information.

The apparatus may further include a user interface unit which receives the existing setting information, and the setting information generating unit may generate the existing setting information according to the received setting information.

The apparatus may further include a setting information storing unit which stores the generated existing setting information.

The apparatus may further include a security checking unit which checks whether the existing setting information requires security; and an encrypting unit which encrypts the existing setting information in response to the checked result and transmits the encrypted setting information to the setting information acquiring unit.

The existing setting information may be location information of a host device connected to the master peripheral through the network.

According to another aspect of the present invention, there is provided a peripheral setting method including: acquiring existing setting information of a master peripheral which is provided on a network; and setting a new peripheral which is newly provided on the network using the acquired existing setting information.

The acquiring of the existing setting information may further include requesting transmission of the existing setting information; and receiving the existing setting information in response to the request.

The acquiring of the existing setting information may include multicasting response request data to at least one peripheral provided on the network; requesting the peripheral which responds to the response request data to transmit the existing setting information; and receiving the existing setting information in response to the request, and the response request data may be data to which the master peripheral can respond and the received existing setting information is the acquired existing setting information.

The setting of the new peripheral may include analyzing the acquired existing setting information and extracting a setting value included in the existing acquired setting information; and setting the new peripheral according to the extracted setting value.

The method may further include generating the setting information, and the acquired existing setting information is the generated existing setting information.

According to another aspect of the present invention, there is provided a computer-readable medium having embodied thereon a computer program for a peripheral setting method including: acquiring existing setting information of a master peripheral which is provided on a network; and setting a new peripheral which is newly provided on the network using the acquired existing setting information.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a reference diagram illustrating a peripheral setting apparatus according to an embodiment of the present invention;

FIG. 2 is a block diagram of a peripheral setting apparatus according to the embodiment of the present invention;

FIG. 3 is a flowchart of a peripheral setting method according to the embodiment of the present invention;

FIG. 4 is a first reference diagram illustrating the peripheral setting method according to the embodiment of the present invention;

FIG. 5 is a second reference diagram illustrating the peripheral setting method according to the embodiment of the present invention;

FIG. 6 is a third reference diagram illustrating the peripheral setting method according to the embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

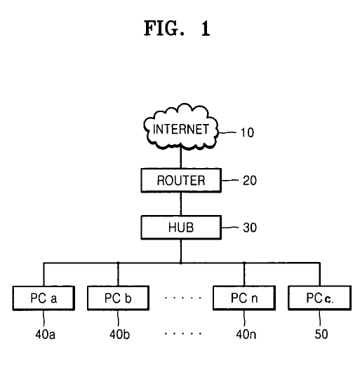

Hereinafter, a peripheral setting method according to an embodiment of the present invention will be described using a simple example of a system including a host device (hereinafter, referred to as “host”), a peripheral A, a peripheral B, and a peripheral C. As shown in FIG. 1, the peripheral 50 and the host devices 40a through 40n are connectable via a network, such as the Internet, through a router 20 and a hub 30. Here, the peripheral A and the peripheral B are understood as being previously provided and the peripheral C is being newly provided. However, it is understood that the present invention is not limited to this arrangement. (Hereinafter, the peripherals which were already provided are referred to as “existing peripherals,” and the peripheral which is newly provided is referred to as a “new peripheral”.)

Each peripheral operates according to the instruction of the host and may include a printer, a scanner, a copier, or a multi-functional peripheral (MFP).

The host may be a personal computer (PC). The peripheral A and peripheral B operate according to the instruction of the host. Thus, the host must recognize the peripheral A and the peripheral B on the network. When the host recognizes both the peripheral A and the peripheral B on the network, both the peripheral A and the peripheral B are set on the network.

The setting information of the peripheral A and the peripheral B is location information of the host on the network. Here, the location information may be the address of a domain name system (DNS) server or the address of a Windows Internet Name Service (WINS) server of the host on the network, as shown in FIG. 5. (Hereinafter, the setting information of the existing peripheral is referred to as “existing setting information”).

As mentioned above, the peripheral must include the setting information so that the host may instruct the peripheral to operate. That is, the peripheral is set according to predetermined setting information. Accordingly, the peripheral C must also be set so as to be recognized by the host on the network. (Hereinafter, setting information of the new peripheral C is referred to as “new setting information”).

Where the new peripheral C is attached to the network having the existing peripheral A and the peripheral B, the new setting information of the peripheral C should be substantially similar to the existing setting information of the peripheral A or the peripheral B, so that the peripheral C efficiently receives instructions from the host.

In the conventional peripheral setting method, the user must know the existing setting information to set the new peripheral. Because, memorizing all the existing setting information is difficult, the user may ask a network manager about the existing setting information or store the existing setting information in a separate storage medium. Accordingly, the user who wants to set the new peripheral using the conventional peripheral setting method is required to perform a troublesome set of operations to set the new peripheral according to the existing setting information.

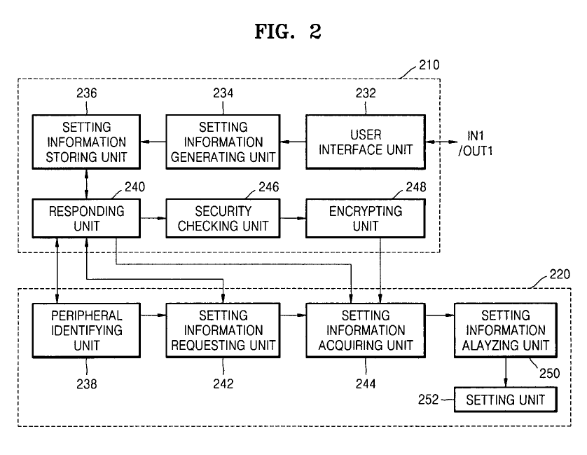

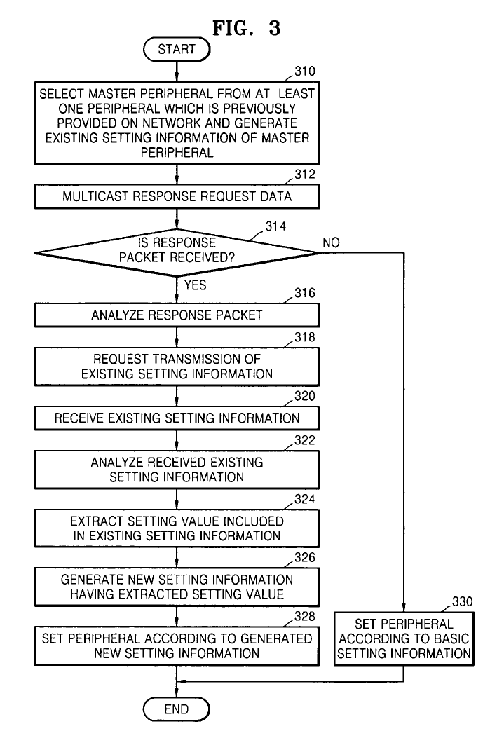

However, according to the peripheral setting apparatus and method of the embodiment of the present invention, the new peripheral acquires the existing setting information from any existing peripheral, generates the new setting information according to the existing setting information, and sets itself according to the setting information. The peripheral setting technology will now be described in detail with reference to FIGS. 2 and 3.

FIG. 2 is a block diagram of a peripheral setting apparatus according to an embodiment of the present invention. The peripheral setting apparatus includes a master peripheral 210, a new peripheral 220, a user interface unit 232, a setting information generating unit 234, a setting information storing unit 236, a peripheral identifying unit 238, a responding unit 240, a setting information requesting unit 242, a setting information acquiring unit 244, a security checking unit 246, an encrypting unit 248, a setting information analyzing unit 250, and a setting unit 252.

The master peripheral 210 has the existing setting information stored therein and provides the existing setting information to the new peripheral 220. If only one existing peripheral is present, then that peripheral is considered to be the master peripheral, and, if multiple existing peripherals are present, then any one of them may be considered to be the master peripheral. Accordingly, if multiple existing peripherals are present, the user must select one to be the master peripheral 210 and provide the existing setting information to the new peripheral 220.

The user interface unit 232 may be provided in either the master peripheral 210 or the host. In the present embodiment, the user interface unit 232 is provided in the master peripheral 210. The user interface unit 232 may receive the existing setting information from the user. The reference term, “IN1,” represents the existing setting information received from the user. The setting information generating unit 234 generates the existing setting information according to content received through the user interface unit 232. That is, the setting information generating unit 234 generates the content received through the user interface unit 232 as the existing setting information. At this time, the generated existing setting information may be displayed through the user interface unit 232. The reference term, “OUT1,” represents the existing setting information displayed through the user interface unit 232. The setting information storing unit 236 stores the existing setting information generated by the setting information generating unit 234. The generated existing setting information is stored in the setting information storing unit 236 to be provided to the master peripheral 210.

The peripheral identifying unit 238 identifies the master peripheral 210. The peripheral identifying unit 238 is provided in the new peripheral 220, and multicasts response request data to all the existing peripherals. That is, the peripheral identifying unit 238 transmits the response request data to all the existing peripherals on the network. Here, the response request data is any data to which only the master peripheral 210 can respond.

When the new peripheral 220 is newly provided on the network, the new peripheral 220 is required to find the existing peripheral, which is able to provide the existing setting information to the new peripheral 220. Here, the existing peripheral, which is able to provide the existing setting information, is the master peripheral 210. Thus, if multiple existing peripherals are present on the network, the new peripheral 220 is to identify the master peripheral.

Accordingly, the peripheral identifying unit 238, provided in the new peripheral 220, transmits the response request data to all the existing peripherals and waits for a predetermined time for a response packet to be transmitted. Here, the predetermined time is set previously. The response packet is any data which notifies the new peripheral that the peripheral which transmits the response packet is the master peripheral 210. Since only the master peripheral 210 recognizes and responds to the response request data, only the master peripheral 210 generates the response packet. The responding unit 240 generates the response packet in response to the response request data.

The responding unit 240 transmits the response packet to the peripheral identifying unit 238. The peripheral identifying unit 238, which receives the response packet, then identifies the master peripheral 210. That is, the peripheral identifying unit 238 distinguishes the existing peripheral which transmits the response packet from the existing peripherals which do not transmit the response packet, to identify the master peripheral 210 from all the existing peripherals. Furthermore, the response packet may include data “protocol” used when the existing setting information of the master peripheral 210 is provided to the new peripheral 220, in addition to the data which notifies that the peripheral which transmits the response packet is the master peripheral 210.

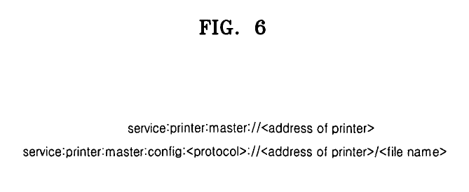

For example, as shown in FIG. 6, the responding unit 240 transmits a response packet such as “service: Printer: master://<address of printer>” to the peripheral identifying unit 238. Here, <address of printer> represents address information of the master peripheral 210 on the network. The master peripheral 210 notifies the peripheral identifying unit 238 that it is the master peripheral 210.

Moreover, as shown in FIG. 6, the responding unit 240 transmits a response packet such as “service: printer: master: config:<protocol>://<address of printer>/<file name>” to the peripheral identifying unit 238. Here, <address of printer> represents address information of the master peripheral 210 on the network, <file name> represents a file name transmitted from the master peripheral 210 to the new peripheral 220, and <protocol> represents the protocol used when the master peripheral 210 transmits the response packet. The protocol includes, for example, an ftp protocol.

The setting information requesting unit 242 requests that the responding unit 240, which transmits the response packet, provide the existing setting information to the setting information acquiring unit 244. At this time, the setting information requesting unit 242 requests that the responding unit 240 provide the existing setting information using the protocol that is used when the existing setting information of the master peripheral 210 is provided to the new peripheral 220.

The responding unit 240 provides the existing setting information stored in the setting information storing unit 236 to the setting information acquiring unit 244 in response to the request of the setting information requesting unit 242. Accordingly, the setting information acquiring unit 244 acquires the existing setting information from the master peripheral 210.

The existing setting information may be provided from the responding unit 240 to the setting information acquiring unit 244 through the security checking unit 246 and the encrypting unit 248. The security checking unit 246 checks whether the existing setting information provided from the responding unit 240 to the setting information acquiring unit 244 of the new peripheral 220 requires security.

For example, the security checking unit 246 may check whether content, which is previously set, is included in the existing setting information that is received from the responding unit 240. Thus, if the content which is previously set is included in the existing setting information, the security checking unit 246 instructs the encrypting unit 248 to encrypt the existing setting information and to provide the encrypted existing setting information to the setting information acquiring unit 244.

If the content which is previously set is not included in the existing setting information, the security checking unit 246 does not instruct the encrypting unit 248 to encrypt the existing setting information and to provide the encrypted existing setting information to the setting information acquiring unit 244.

The setting information analyzing unit 250 analyzes the acquired existing setting information and extracts a setting value included in the acquired existing setting information. The setting unit 252 sets the new peripheral 220 according to the extracted setting value. Accordingly, the new peripheral 220 automatically generates the new setting information using the existing setting information. That is, the setting unit 252 automatically sets the new peripheral 220 using the existing setting information received from the responding unit 240 of the master peripheral 210.

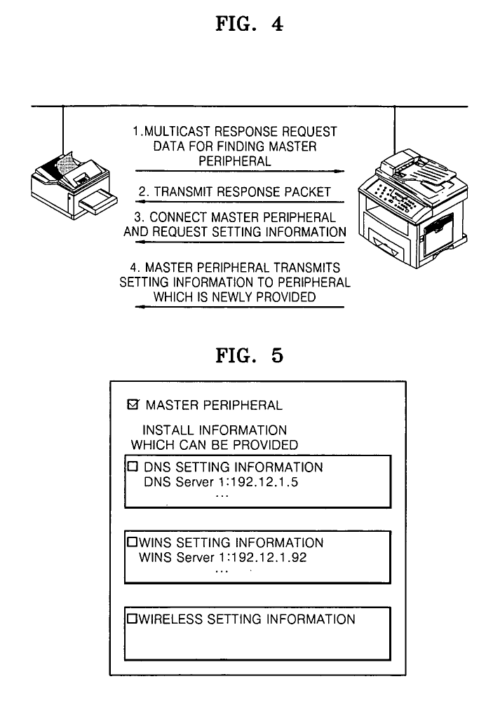

FIG. 3 is a flowchart of a peripheral setting method according to an embodiment of the present invention. The peripheral setting method includes operations 310 through 314 of identifying the master peripheral 210 from all the existing peripherals, operations 316 through 320 of requesting the master peripheral 210 to provide the existing setting information and receiving the existing setting information according to the request, and operations 322 through 330 of setting the new peripheral 220 using the received existing setting information. FIG. 4 is a diagram reconfiguring the flowchart shown in FIG. 3.

Initially, the user who wants to add the new peripheral 220 to the network having the existing peripherals selects an existing peripheral from the existing peripherals to be the master peripheral 210.

When the master peripheral 210 does not include the existing setting information or the existing setting information of the master peripheral 210 must be changed, the setting information generating unit 234 generates the existing setting information. Thus, the master peripheral 210 includes the generated existing setting information (operation 310). At this time, in an embodiment of the invention, the generated existing setting information is stored in the setting information storing unit 236 of the master peripheral 210.

When the master peripheral 210 does not include the existing setting information, the setting information generating unit 234 initially generates the existing setting information. When the existing setting information of the master peripheral 210 must be changed, the setting information generating unit 234 newly generates the existing setting information.

The peripheral identifying unit 238 multicasts the response request data (operation 312). Here, only the master peripheral 210 responds to the response request data.

The peripheral identifying unit 238 waits the predetermined time for the response packet to be transmitted and checks whether the response packet is transmitted within the predetermined time (operation 314).

In operation 314, if the response packet is transmitted within the predetermined time, the peripheral identifying unit 238 analyzes the transmitted response packet (operation 316). The peripheral identifying unit 238 distinguishes the master peripheral, which transmits the response packet, from the other existing peripherals and, thus, identifies the master peripheral from all the existing peripherals.

The setting information requesting unit 242 requests that the master peripheral 210 provides the existing setting information to the setting information acquiring unit 244 (operation 318). The responding unit 240 of the master peripheral 210 provides the existing setting information stored in the setting information storing unit 236 to the setting information acquiring unit 244 in response to the request. Accordingly, the setting information acquiring unit 244 acquires the existing setting information (operation 320).

The setting information analyzing unit 250 analyzes the acquired existing setting information (operation 322) and extracts the setting value included in the acquired existing setting information (operation 324). The setting unit 252 generates the new setting information having the extracted setting value (operation 326) and sets the new peripheral 220 according to the generated new setting information (operation 328).

In operation 314, if the response packet is not transmitted within the predetermined time, the setting unit 252 sets the new peripheral 220 according to basic setting information, which is previously set as a default (operation 330).

The invention may also be embodied as computer readable code on a computer readable recording medium. The computer readable recording medium is any data storage device that stores data which may be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the internet). The computer readable recording medium may also be distributed over network coupled computer systems so that the computer readable code is stored and executed in a distributed fashion. Also, functional programs, code, and code segments to accomplish the present invention may be easily construed by programmers skilled in the art to which the present invention pertains.

As is mentioned above, according to aspects of the peripheral setting apparatus and the methods of the present invention, since the new peripheral which is newly provided on the network is automatically set using the existing setting information of the master peripheral which is previously provided on the network, to generate the new setting information of the new peripheral, the new setting information may be generated without a troublesome operation of inputting the new setting information. Accordingly, the user who wants to set the new peripheral need not, for example, need not know the existing setting information or be required to ask a network manager about the new setting information. That is, by connecting the new peripheral to the master peripheral through a network, the new peripheral may be set automatically.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A peripheral setting apparatus, comprising:
a setting information acquiring unit which acquires setting information of a master peripheral that is provided on a network; and
a setting unit which sets a new peripheral that is newly provided on the network using the acquired setting information.

2. The apparatus according to claim 1, wherein the master peripheral is previously provided on the network.

3. The apparatus according to claim 1, further comprising:
a setting information requesting unit which requests a transmission of the setting information; and
a responding unit which transmits the setting information and information on a protocol used when the setting information is transmitted to the setting information acquiring unit in response to the request.

4. The apparatus according to claim 3, further comprising a peripheral identifying unit which multicasts response request data, to which only the master peripheral responds, to at least one peripheral provided on the network, wherein the setting information requesting unit requests the transmission of the setting information to the responding unit provided to the peripheral which responds to the response request data.

5. The apparatus according to claim 1, further comprising a setting information analyzing unit which analyzes the acquired setting information and which extracts a setting value included in the acquired setting information, wherein the setting unit sets the new peripheral according to the extracted setting value.

6. The apparatus according to claim 1, further comprising a setting information generating unit which generates the setting information, wherein the acquired setting information is the generated setting information.

7. The apparatus according to claim 6, further comprising a user interface unit which receives the setting information, wherein the setting information generating unit generates the setting information according to the received setting information.

8. The apparatus according to claim 7, wherein the user interface unit is provided in the new peripheral or a host device connected to the new peripheral through the network.

9. The apparatus according to claim 6, further comprising a setting information storing unit which stores the generated setting information.

10. The apparatus according to claim 1, further comprising:
a security checking unit which checks whether the setting information requires security; and
an encrypting unit which encrypts the setting information in response to the checked result and transmits the encrypted setting information to the setting information acquiring unit.

11. The apparatus according to claim 1, wherein the setting information includes at least one of DNS (domain name system) information and WINS (Windows Internet Name Service) information of a host device connected to the master peripheral through the network.

12. A peripheral setting method, comprising:
acquiring setting information of a master peripheral which is provided on a network; and
setting a new peripheral which is newly provided on the network using the acquired setting information.

13. The method according to claim 12, wherein the master peripheral is previously provided on the network.

14. The method according to claim 12, wherein the acquiring of the setting information comprises:
requesting a transmission of the setting information; and
receiving the setting information and information on a protocol used when the setting information is transmitted, in response to the request.

15. The method according to claim 12, wherein the acquiring of the setting information comprises:
multicasting response request data to at least one peripheral provided on the network;
requesting that the peripheral, which responds to the response request data, transmits the setting information; and
receiving the setting information and information on a protocol used when the setting information is transmitted, in response to the request, wherein the response request data is data to which the master peripheral responds and the received setting information is the acquired setting information.

16. The method according to claim 12, wherein the setting of the new peripheral comprises:
analyzing the acquired setting information and extracting a setting value included in the acquired setting information; and
setting the new peripheral according to the extracted setting value.

17. The method according to claim 12, further comprising generating the setting information, wherein the acquired setting information is the generated setting information.

18. A computer-readable medium having embodied thereon a computer program to execute the method of claim 12.

19. A method of adding a new peripheral to a network on which peripherals, including a master peripheral, are present, comprising:
acquiring setting information of the master peripheral when the new peripheral is to be added; and
setting the new peripheral which is newly provided on the network using the acquired setting information.

20. The method according to claim 19, wherein the acquiring of the setting information comprises:
multicasting response request data to the peripherals present on the network;
requesting that the peripheral, which responds to the response request data, transmits the setting information; and
receiving the setting information.

21. The method according to claim 19, wherein the setting of the new peripheral comprises:
analyzing the acquired setting information;
extracting a setting value included in the acquired setting information; and
setting the new peripheral according to the extracted setting value.

22. The method according to claim 19, further comprising generating the setting information.

23. A computer-readable medium having embodied thereon a computer program to execute the method of claim 19.

24. A method of adding a new peripheral to a network on which peripherals are present, comprising:
selecting a master peripheral from among the peripherals and generating setting information from the setting information of the master peripheral;
broadcasting response request data when the new peripheral is to be added; and
setting the new peripheral according to basic setting information if no response is received, or, if a response, including the setting information, is received, setting the new peripheral according to new setting information, generated from the setting information, for use in the new peripheral.

25. The method according to claim 24, wherein the setting of the new peripheral according to the setting information comprises:
analyzing the response;
requesting a transmission of the setting information;
receiving the setting information;
analyzing the received setting information;
extracting a setting value from the setting information; and
generating the new setting information according to the extracted value.
